(19) United States
(12) Patent Application Publication
(10) Pub. No.: US 2022/0360716 A1
(43) Pub. Date: Nov. 10, 2022

(54) IMAGING APPARATUS

(71) Applicant: SHARP KABUSHIKI KAISHA, Sakai City (JP)

(72) Inventors: DAISHI MIYAZAKI, Sakai City (JP); HIDENORI FUJISAWA, Sakai City (JP)

(21) Appl. No.: 17/717,618

(22) Filed: Apr. 11, 2022

(30) Foreign Application Priority Data
May 7, 2021 (JP) 2021-079365

(51) Int. Cl. H04N 5/232

(52) U.S. Cl. CPC H04N 5/23296; H04N 5/232935

(57) ABSTRACT

A mobile terminal, which is an imaging apparatus, includes a camera, which is an imaging unit, a display unit, a zoom processing unit, and an accepting unit. The display unit displays an image that is captured. The zoom processing unit performs zoom processing to an image that is captured. The accepting unit accepts an input of an amount of processing of the zoom processing. A modulation transfer function value in a peripheral portion of a lens in the camera is set so as to be lower than the modulation transfer function value in a central portion of the lens. The zoom processing unit performs the zoom processing so that the central portion is used in default shooting by the camera and sets an angle of view resulting from the zoom processing as a default angle of view.

### BACKGROUND

### 1. Field

The present disclosure relates to an imaging apparatus including a lens and an imaging device.

### 2. Description of the Related Art

The numbers of pixels are being increased in imaging apparatuses, such as smartphones and mobile phones, including cameras, which are imaging units. The height (thickness) of the camera tends to be increased as the number of pixels is increased. Accordingly, in order to mount the camera in the thin imaging apparatus, such as the smartphone, the height of the camera is decreased to achieve low profile.

As one method of lowering the profile, use of wide-angle lenses has hitherto been performed (for example, Japanese Unexamined Patent Application Publication No. 2015-072424). Since the wide-angle lens has a short focal length, the distance between the lens and the imaging device is short to achieve the low profile of the camera.

The height of the camera may not be fitted to a desired value only with the technique to achieve the low profile of the camera using the wide-angle lens described above. For example, this corresponds to a case in which the imaging device has a large size. Since the increase in size of the imaging device increases the size of the lens to increase the height (thickness) of the lens, it is not possible to fit the height of the camera to the desired value.

It is desirable to realize an imaging apparatus lowering the profile of an imaging unit, which is a camera, in a point of view different from the focal length of the lens.

### SUMMARY

In order to resolve the above problems, an imaging apparatus according to an aspect of the present disclosure includes an imaging unit; a display unit that displays an image captured by the imaging unit; a zoom processing unit (an image processor) that performs zoom processing to an image captured by the imaging unit; and an accepting unit that accepts an input of an amount of processing by the zoom processing unit. The imaging unit includes a lens. A modulation transfer function value in a peripheral portion of the lens is set so as to be lower than the modulation transfer function value in a central portion of the lens. The zoom processing unit performs the zoom processing so that the central portion is used in default shooting by the imaging unit and sets an angle of view resulting from the zoom processing as a default angle of view.

### BRIEF DESCRIPTION OF THE DRAWINGS

FIG. 1 includes diagrams for describing the external appearance of a mobile terminal according to an embodiment;

FIG. 2 is a functional block diagram illustrating an example of the schematic configuration of the mobile terminal illustrated in FIG. 1;

FIG. 3 is a schematic diagram illustrating an example of the structure of a camera mounted in the mobile terminal illustrated in FIG. 1;

FIG. 4 is a flowchart illustrating a process of designing a lens unit in the camera mounted in the mobile terminal illustrated in FIG. 1;

FIG. 5 is a graph illustrating the relationship between a lens performance and an image height of the lens unit in the camera mounted in the mobile terminal illustrated in FIG. 1;

FIG. 6 is a diagram for describing the image height;

FIG. 7 is a diagram illustrating an imaging area of the mobile terminal illustrated in FIG. 1 and the imaging area of a mobile terminal in the related art having three cameras: an ultra wide-angle camera, a wide-angle camera, and a telephoto camera mounted therein;

FIG. 8 is a diagram illustrating a full angle of view and a default angle of view of the camera in the mobile terminal illustrated in FIG. 1;

FIG. 9 is a table indicating the relationship between an internal zoom factor and a UI display zoom factor of the camera in the mobile terminal illustrated in FIG. 1; and

FIG. 10 is a flowchart illustrating an imaging process in the mobile terminal illustrated in FIG. 1.

### DESCRIPTION OF THE EMBODIMENTS

Imaging apparatuses according to embodiments of the present disclosure will herein be described with reference to the drawings. The same reference numerals are used to identify the same components in the following description. The same applies to the names and the functions of the components. Accordingly, a detailed description of such components is not repeated.

An imaging apparatus is, for example, a mobile terminal such as a smartphone, a tablet computer, or a digital camera. A mobile terminal having an imaging function will be exemplified as the imaging apparatus in the following description.

### 1. Configuration of Mobile Terminal

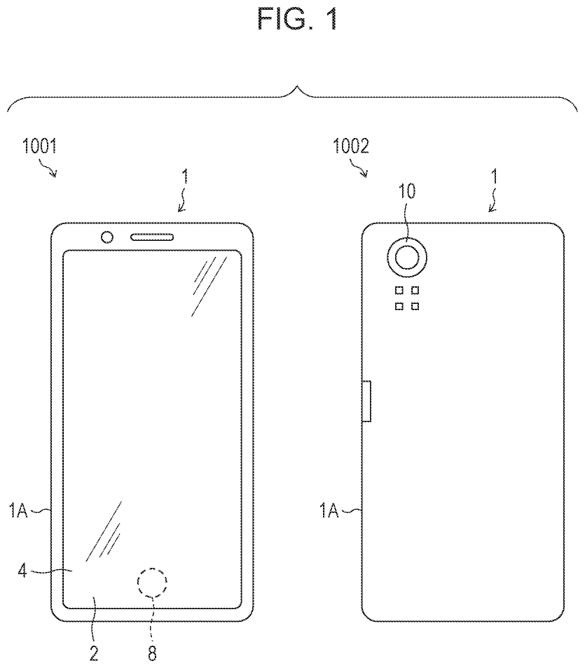

FIG. 1 includes diagrams for describing the external appearance of a mobile terminal 1 according to an embodiment. Reference numeral 1001 denotes a front view of the mobile terminal 1 and reference numeral 1002 denotes a rear view of the mobile terminal 1.

As illustrated in the front view 1001, the mobile terminal 1 includes a display unit 2, an operation unit 4, and so on on the front side face of a case 1A. The display unit 2 has a touch panel function and includes the operation unit (accepting unit) 4. As illustrated in the rear view 1002, the mobile terminal 1 includes a camera (imaging unit) 10 on the rear side face opposed to the front side face of the case 1A. The camera 10 captures an image of a subject which a user of the camera 10 can see.

Upon activation of an application (hereinafter referred to as an “imaging application”) for realizing the imaging function by the user on the mobile terminal 1, the camera 10 starts to capture an image and the display unit 2 displays the image captured by the camera 10 and an imaging switch 8. Activation of the application for realizing the imaging function is hereinafter referred to as activation of the camera 10. Termination of the application for realizing the imaging function is hereinafter referred to as termination of the camera 10.

Upon touch of the imaging switch 8 by the user, the mobile terminal 1 can capture the image displayed in the display unit 2 as one picture. In the case of a movie, the mobile terminal 1 can start to shot the movie. Upon touch of the display unit 2 by the user to perform a zoom-in operation to enlarge the image of a portion where the user touches for display, the display unit 2 displays an enlarged image. Upon touch of the display unit 2 by the user to perform a zoom-out operation to reduce the image of a portion where the user touches for display, the display unit 2 displays a reduced image.

The magnification of the enlarged image depends on the amount of operation of the zoom-in operation. Similarly, the magnification of the reduced image depends on the amount of operation of the zoom-out operation. In addition, a limited magnification is set for each of the enlargement magnification and the reduction magnification and the image is enlarged and reduced to the limited magnifications.

### 2. Functional Blocks of Mobile Terminal

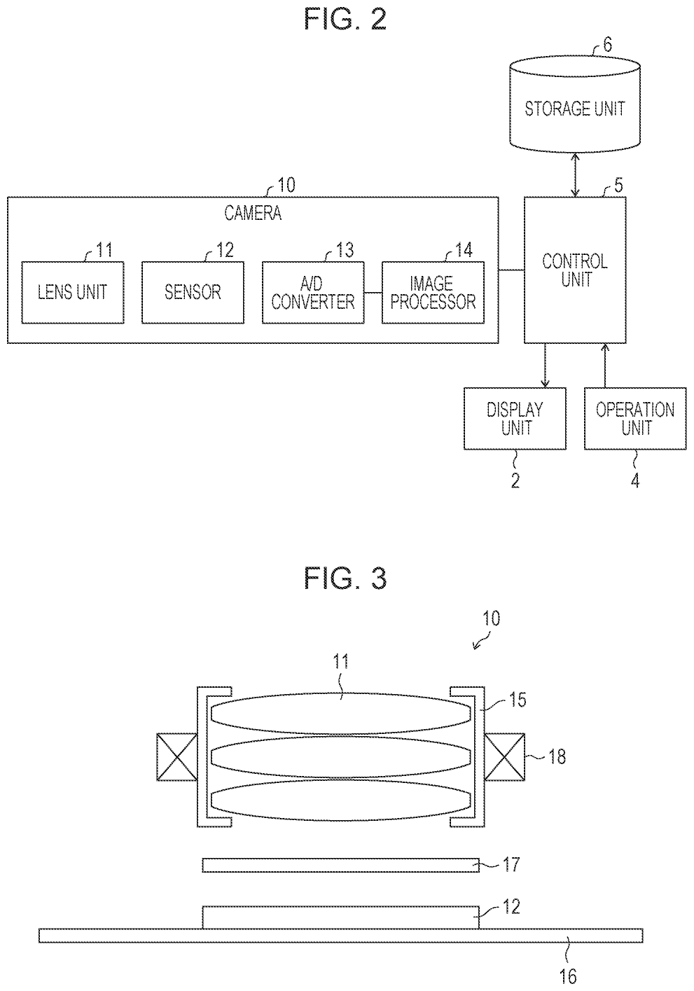

FIG. 2 is a functional block diagram illustrating an example of the schematic configuration of the mobile terminal 1. Referring to FIG. 2, the mobile terminal 1 includes a control unit 5 and a storage unit 6, in addition to the camera 10, the display unit 2, and the operation unit 4 described above.

The control unit 5 executes a control program to control the camera 10 and the display unit 2. The control unit 5 reads out the control program stored in the storage unit 6 into a temporary storage unit (not illustrated) composed of a random access memory (RAM) or the like and executes the control program that is read out to perform various processes. The control unit 5 has the function of a zoom processor that performs zoom processing to an image captured by the camera 10.

The operation unit 4 accepts inputs of various operation instructions by the user, which include an operation instruction to the camera 10. The operation unit 4 also serves as an accepting unit that accepts an input of the amount of processing by an image processor (zoom processor) 14 described below. Although the touch panel function of the display unit 2 is exemplified as the operation unit 4 in the present embodiment, the operation unit 4 may be composed of operation buttons, an interface of the operation buttons, and so on.

The display unit 2 displays various images including an image captured by the camera 10. The display unit 2 is, for example, a liquid crystal display or a light emitting display (for example, an organic light emitting display (OLED)).

The storage unit 6 stores (1) the control programs of the respective components, (2) an operating system (OS) program, and (3) various application programs including the imaging application, which are executed by the control unit 5. The storage unit 6 also stores (4) a variety of data that is read out in execution of the programs.

The camera 10 includes a lens unit 11, a sensor 12, an analog-to-digital (A/D) converter 13, and the image processor 14. Upon reception of imaging light by the sensor 12, the imaging by the camera 10 is performed. Photocurrent caused by the reception of the imaging light by the sensor 12 is supplied to the A/D converter 13. The A/D converter 13 converts an analog signal supplied from the sensor 12 into a digital signal.

The image processor 14 performs image processing to the image (image data) supplied from the A/D converter 13. The image processing includes certain pixel interpolation, color conversion, and so on. The image processor 14 accepts operation instructions to the camera 10, which is input by the user with the operation unit 4, via the control unit 5 to perform various processes. The image generated in the image processor 14 is supplied to the control unit 5 and is displayed in the display unit 2 via the control unit 5. The image displayed in the display unit 2 may be stored in the storage unit 6.

### 3. Configuration of Camera 10

FIG. 3 is a schematic diagram illustrating an example of the structure of the camera 10 mounted in the mobile terminal 1. Referring to FIG. 3, the camera 10 includes the lens unit 11, the sensor 12, an actuator 18, a lid glass 17, and so on.

The lens unit 11 includes multiple lenses that are stacked. The multiple lenses in the lens unit 11 are integrated with each other using a lens barrel 15. The sensor 12 is, for example, a color image sensor or a monochrome image sensor, which is composed of a complementary metal oxide semiconductor (CMOS), a charge coupled device (CCD), or the like. The sensor 12 is mounted on a substrate 16 and converts an optical signal received through the lens unit 11 into an electrical signal.

The actuator 18 is composed of, for example, a voice coil motor (VCM). The actuator 18 controls driving of the lens unit 11 in an optical axis direction to realize an automatic focusing (AF) function. The lid glass 17 has light transmission characteristics. The lid glass 17 transmits light having a predetermined wavelength and blocks light having a wavelength other than the predetermined wavelength.

### 4. Designing of Lens Unit 11

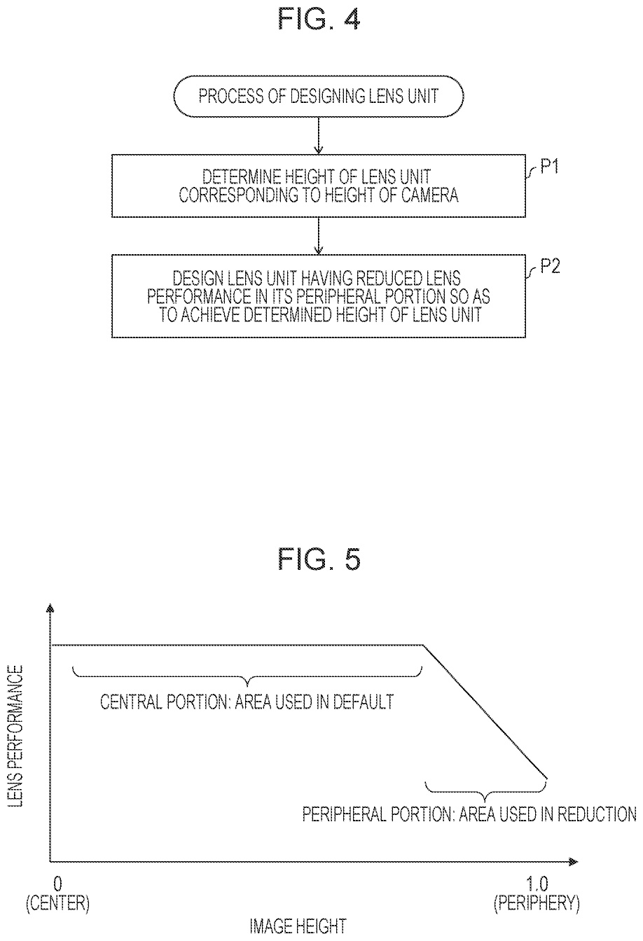

FIG. 4 is a flowchart illustrating a process of designing the lens unit 11 in the camera 10. The process of designing the lens unit 11 is included in a designing process of the mobile terminal 1. The designing process of the mobile terminal 1 is included in a manufacturing process of the mobile terminal 1.

As illustrated in FIG. 4, the process of designing the lens unit 11 in the camera 10 includes Step P1 and Step P2. In Step P1, the height of the lens unit 11, which corresponds to the height of the camera 10, is determined. For example, in the case of the thin mobile terminal 1, such as a smartphone, the height of the camera 10 is restricted and is determined in consideration of the dimension in the thickness direction of the mobile terminal 1.

The height of the camera 10 is the module height of a camera module composing the camera 10. Upon determination of the height of the camera 10, the height permitted for the lens unit 11 is determined in consideration of the thicknesses of the respective components composing the camera 10, the distances between the components composing the camera 10, and so on. The height of the camera 10 is influenced by the sensor 12 and the substrate 16, which are illustrated in FIG. 3. The height of the camera 10 is also influenced by a terminal camera window member (not illustrated) placed at the opposite side of the lens unit 11 with respect to the sensor 12 and a support member (not illustrated) supporting the terminal camera window member, and so on. The distances between the respective components include, for example, the focal length of the lenses in the lens unit 11 and the distance by which the lens unit 11 moves in the optical axis direction in the automatic focusing (AF) function.

In Step P2, the lens unit 11 having a reduced lens performance in its peripheral portion (outer periphery) is designed so as to the achieve the height of the lens unit 11 determined in Step P1.

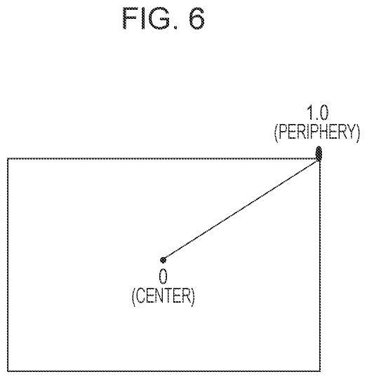

FIG. 5 is a graph illustrating the relationship between the lens performance and the image height of the lens unit 11 in the camera 10. FIG. 6 is a diagram for describing the image height. As illustrated in FIG. 6, the image height is a value represented by setting the center of the sensor 12 through which the center of the optical axis of the lens unit 11 passes to “0 (zero)” and setting the position on the sensor 12, which is most apart from the center, to “1.0”.

Modulation transfer function (MTF) characteristics, which is one index indicating the resolution of the lens, may be used as the lens performance. The lens performance is increased as the MTF value is increased and the lens performance is decreased as the MTF value is decreased.

As illustrated in FIG. 5, in the lens unit 11, the MTF value in the peripheral portion is set so as to be lower than the MTF value in a central portion. In the present embodiment, the MTF value is kept constant (substantially constant) in the central portion of the lens unit 11 and is linearly decreased from the boundary with the central portion of the lens unit 11 toward the outer edge of the lens unit 11 in the peripheral portion of the lens unit 11. The boundary between the central portion having higher MTF values and the peripheral portion having lower MTF values is set to a position more apart from the center of the lens unit 11 as long as the position is permitted by the height of the lens unit 11. Although, in general, the MTF value is linearly decreased with respect to the image height, the lens unit 11 is designed so that the MTF value is kept constant (substantially constant) in the central portion and the MTF value is sharply decreased in the peripheral portion.

In the present embodiment, the camera 10 is a so-called ultra wide-angle camera having a 35 mm equivalent focal length of about 20 mm or less. The lens unit 11 is designed so that an area used at a certain value between about 23 mm and about 26 mm of the 35 mm equivalent focal length is within the central portion having higher MTF values.

The image processor 14 described below performs the zoom processing so that the 35 mm equivalent focal length is equal to a certain value between about 23 mm to about 26 mm in default shooting by the camera 10 and sets the angle of view resulting from the zoom processing as a default angle of view.

### 5. Default Setting in Camera 10 in Mobile Terminal 1

The mobile terminal 1 performs the zoom processing so that the 35 mm equivalent focal length is equal to a certain value between about 23 mm to about 26 mm in the default shooting by the camera 10 and sets the angle of view resulting from the zoom processing as the default angle of view. In other words, in the default shooting by the camera 10, the mobile terminal 1 displays in the display unit 2 not an image at a full angle of view of the camera 10, which is the ultra wide-angle camera, but an image resulting from the zoom processing (enlargement) into a certain value between about 23 mm and about 26 mm of the 35 mm equivalent focal length. Even when the lens performance in the peripheral portion of the lens unit 11 is reduced, setting the angle of view resulting from the zoom processing as the default angle of view causes an image captured in the portion having a reduced lens performance not to be used in the default shooting.

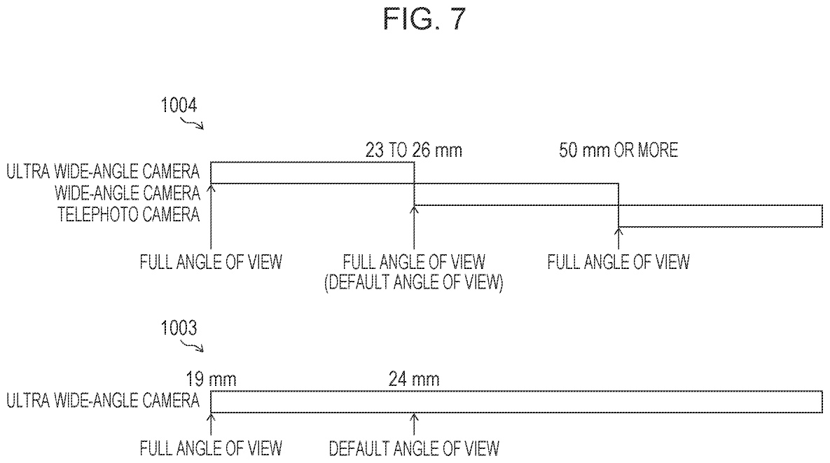

FIG. 7 is a diagram illustrating an imaging area of the mobile terminal 1 and the imaging area of a mobile terminal in the related art having three cameras: an ultra wide-angle camera, a wide-angle camera, and a telephoto camera mounted therein. Referring to FIG. 7, reference numeral 1003 denotes the imaging area of the mobile terminal 1 and reference numeral 1004 denotes the imaging area of the mobile terminal in the related art.

As illustrated in reference numeral 1004, in the mobile terminal in the related art having the three cameras mounted therein, the default angle of view is the full angle of view of the wide-angle camera. The angle of view of the wide-angle camera, which is varied depending on the model of the camera, is about 23 mm to about 26 mm of the 35 mm equivalent focal length. As illustrated in reference numeral 1004 in FIG. 7, the extreme left of the zone of each of the ultra wide-angle camera, the wide-angle camera, and the telephoto camera is the full angle of view and the right side of the full angle of view is the angle of view subjected to the zoom processing (the angle of view resulting from the zoom processing).

As illustrated in reference numeral 1003, the default angle of view of the mobile terminal 1 of the present embodiment is about 24 mm of the 35 mm equivalent focal length, which results from the zoom processing of an image captured at about 19 mm of the 35 mm equivalent focal length, which is not longer than about 20 mm of the 35 mm equivalent focal length corresponding to the ultra wide-angle camera.

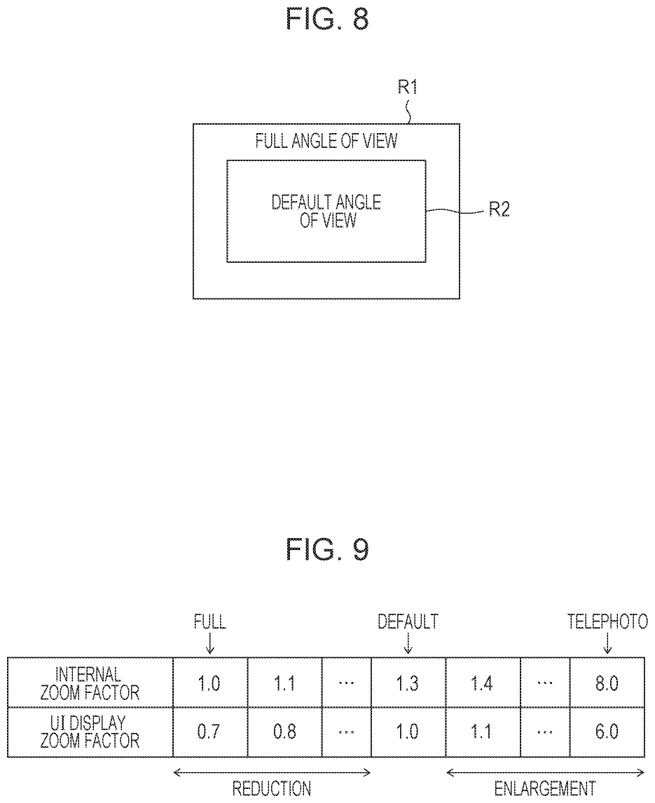

FIG. 8 is a diagram illustrating the full angle of view and the default angle of view of the camera 10 in the mobile terminal 1. As illustrated in FIG. 8, a default angle of view R2 of the camera 10 is smaller than a full angle of view R1 of the camera 10. In the mobile terminal 1, the image (image data) at the default angle of view R2 is subjected to the zoom processing and the image resulting from the zoom processing is displayed in the display unit 2. The operation unit 4 accepts the zoom-in operation and the zoom-out operation based on the image at the default angle of view R2. In other words, a state in which the image at the default angle of view R2 is enlarged and the enlarged image is displayed in the display unit 2 corresponds to the magnification “1.0” on a user interface (UI).

In the present embodiment, the 35 mm equivalent focal length corresponding to the full angle of view R1 of the camera 10 is, for example, about 19 mm (the angle of view of about 98 degrees) and the 35 mm equivalent focal length corresponding to the default angle of view R2 is, for example, set to about 24 mm (the angle of view of about 82 degrees).

In other words, in the present embodiment, the magnification “about 1.3 times (24 mm/19 mm) of the image processor 14 in the camera 10 is set to the magnification “1.0” on the UI, which is the reference of a user's operation. The magnification of the image processor 14 is also referred to as an internal zoom factor and the magnification on the UI is also referred to as a UI display zoom factor.

FIG. 9 is a table T indicating the relationship between the internal zoom factor and the UI display zoom factor of the camera 10 in the mobile terminal 1. The table T is stored in, for example, the storage unit 6 and reads out by the control unit 5 in the mobile terminal 1. Upon activation of the camera 10, the control unit 5 reads out the table T and displays an image enlarged at the internal zoom factor “1.3” corresponding to the UI display zoom factor “1.0” in the display unit 2. When the zoom-in operation is performed by the user and, for example, the UI display zoom factor “1.1” is instructed, the control unit 5 displays an image enlarged at the internal zoom factor “1.4”, which is more magnified than the default setting (the internal zoom factor “1.3”), in the display unit 2. When the zoom-out operation is performed by the user and, for example, the UI display zoom factor “0.7” is instructed, the control unit 5 displays an image at the same magnification as the internal zoom factor “1.0”, which is more reduced than the default setting (the internal zoom factor “1.3”), in the display unit 2. The image more reduced than the default setting is a wider-angle image including an area wider than that in the default setting.

The operation unit 4 accepts an input of the amount of processing using the default angle of view as the zoom factor of one by associating the internal zoom factor, which is the actual zoom factor, with the UI display zoom factor, which is the zoom factor viewed from the user, in the above manner. As a result, even if the default angle of view is the angle of view resulting from the zoom processing, it is possible for the user to shoot an image with the camera 10 in the same manner as in products in the related art without feeling a sense of strangeness.

In the present embodiment, the control unit 5 in the mobile terminal 1 has the function of the zoom processor and performs the enlargement of an image (image data) captured by the camera 10, as described above. Accordingly, the control unit 5 displays an image resulting from enlargement of the image at the full angle of view, which supplied from the camera 10, at the internal zoom factor “1.3” in the display unit 2 in the default shooting. Upon issuance of an instruction to change from the UI display zoom factor “1.0” in response to the zoom-in operation or the zoom-out operation by the user, the control unit 5 performs the enlargement or the reduction in accordance with the amount of instruction based on the image enlarged at the internal zoom factor “1.3” to display the enlarged or reduced image in the display unit 2.

The zoom processing of an image captured by the camera 10 may be performed in the image processor 14 in the camera 10. In this case, the image processor 14 in the camera 10 may hold the table T. Alternatively, the control unit 5 may supply the table T read out from the storage unit 6 to the image processor 14 in the camera 10. In the configuration in which the image processor 14 in the camera 10 performs the zoom processing, an image enlarged at the internal zoom factor corresponding to the UI display zoom factor is supplied from the image processor 14 to the control unit 5.

### 6. Imaging Operation in Mobile Terminal 1

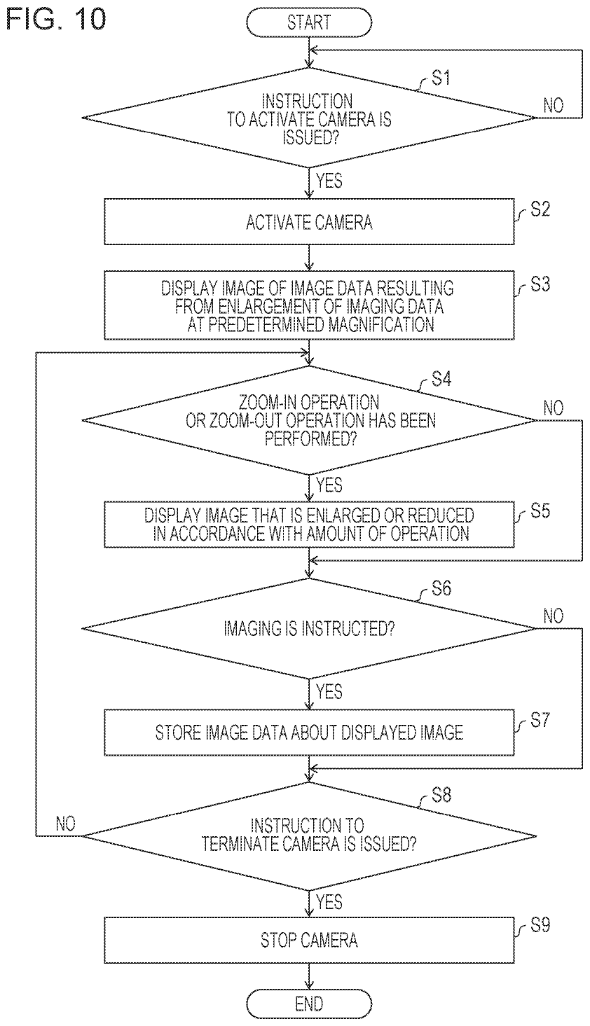

FIG. 10 is a flowchart illustrating an imaging process in the mobile terminal 1. Referring to FIG. 10, in Step S1, the control unit 5 repeatedly determines whether an instruction to activate the camera 10 is issued. For example, when the user touches an icon or the like of the imaging application displayed in the display unit 2, the control unit 5 determines that the instruction to activate the camera 10 is issued. If the control unit 5 determines that the instruction to activate the camera 10 is issued (YES in Step S1), in Step S2, the control unit 5 activates the camera 10. The camera 10 starts to capture an image in response to the activation.

In Step S3, the control unit 5 displays an image resulting from enlargement of an image (image data) captured by the camera 10 at a predetermined magnification, at a magnification of 1.3 here, in the display unit 2 as the default setting. Even if the orientation of the mobile terminal 1 is varied to change the subject to be shot by the camera 10, the image resulting from enlargement of the captured image at the magnification of 1.3 is displayed in the display unit 2 unless the zoom-in (enlargement) operation or the zoom-out (reduction) operation is performed.

In Step S4, the control unit 5 repeatedly determines whether the zoom-in operation or the zoom-out operation has been performed after activating the camera 10. If the control unit 5 determines that the zoom-in operation or the zoom-out operation has been performed (YES in Step S4), in Step S5, the control unit 5 displays an image that is zoomed in or zoomed out in accordance with the amount of operation in the display unit 2. Then, the process goes to Step S6. If the control unit 5 determines that the zoom-in operation or the zoom-out operation has not been performed (NO in Step S4), the process skips Step S5 and goes to Step S6.

In Step S6, the control unit 5 determines whether imaging is instructed. For example, the control unit 5 determines that the imaging is instructed when the user touches the imaging switch 8 displayed in the display unit 2. If the control unit 5 determines that the imaging is instructed (YES in Step S6), in Step S7, the control unit 5 stores the image that is being displayed in the display unit 2 in the storage unit 6. Then, the process goes to Step S8. If the control unit 5 determines that the imaging is not instructed (NO in Step S6), the process skips Step S7 and goes to Step S8.

In Step S8, the control unit 5 determines whether an instruction to terminate the camera 10 is issued. If the control unit 5 determines that the instruction to terminate the camera 10 is issued (YES in Step S8), in Step S9, the control unit 5 terminates the imaging application and stops the function of the camera 10. If the control unit 5 determines that the instruction to terminate the camera 10 is not issued (NO in Step S8), the process goes back to Step S4. Steps S4, S6, and S8 are repeatedly performed until the control unit 5 determines that the instruction to terminate the camera 10 is issued (YES in Step S8).

### 7. Advantages of Mobile Terminal 1

As described above, in the camera 10 in the mobile terminal 1, the height (thickness) of the lens unit 11 is decreased by designing the camera 10 so that the MTF value of the lens unit 11 in the peripheral portion is made lower that in the central portion to lower the profile of the camera 10. Since the profile of the camera is lowered in a point of view different from that in a method of widening the angle of view of the lens to decrease the focal length, it is possible to further lower the profile of the camera using the above method even in a situation in which the profile of the camera is not further lowered using the method of widening the angle of view of the lens.

Although the MTF value in the peripheral portion of the lens unit 11 is made lower than the MTF value in the central portion thereof, the image processor 14 performs the zoom processing so that the central portion is used in the default shooting and sets the angle of view resulting from the zoom processing as the default angle of view. Accordingly, an image captured in the portion where the MTF value is decreased is not used in the default shooting and the influence of the reduction in the MTF performance in the peripheral portion is reduced.

In addition, setting the angle of view resulting from the zoom processing as the default angle of view also achieves the following advantages.

1) The camera 10 is the ultra wide-angle camera. If the image at the full angle of view captured by the camera 10 is displayed in the display unit 2 as the default setting, the imaging area is too wide and the subject to be shot is made small. As a result, the user feels a sense of strangeness. In the above configuration, in the default shooting, the zoom processing is performed not to the full angle of view of the camera 10, which is the ultra wide-angle camera, but to a predetermined angle of view smaller than the full angle of view and the angle of view resulting from the zoom processing is used as the default angle of view. Accordingly, the user is capable of operating the camera 10 without a sense of strangeness and the camera 10 is user-friendly. However, the configuration in which the thickness of the lens is decreased by making the lens performance (MTF value) in the peripheral portion of the lens lower than that in the central portion thereof to lower the profile of the camera is not limited to the combination with the ultra wide-angle camera and is applicable to a combination with the wide-angle camera.

2) Since the camera 10, which is one ultra wide-angle camera, supports the imaging area of the wide-angle camera, it is possible to reduce the cost, compared with the configuration of a mobile terminal including both the ultra wide-angle camera and the wide-angle camera. In addition, setting the angle of view resulting from the zoom processing as the default angle of view enables the zoom-out operation to make the angle of view wider than the default angle of view to provide an operational feeling in a case in which both the wide-angle camera and the ultra wide-angle camera are mounted.

3) Furthermore, one camera 10 supports the imaging area of the telephoto camera in the mobile terminal 1. Accordingly, it is possible to reduce the cost more effectively, compared with the configuration of a mobile terminal including the three cameras: the ultra wide-angle camera, the wide-angle camera, and the telephoto camera.

A configuration may be adopted in which the telephoto camera is provided separately from the camera 10. In other words, a configuration may be adopted in which a second camera (a second imaging unit) having a 35 mm equivalent focal length of about 50 mm or more is provided, in addition to the camera 10, which is a first camera (a first imaging unit). In this case, the control unit in the mobile terminal switches the camera that is used from the first camera (the camera 10) to the telephoto second camera, for example, if the UI display zoom factor exceeds two.

### Examples of Realization Using Software

The functions of the mobile terminal 1 may be realized by a program that causes a computer to function as the mobile terminal 1, specifically, that causes the computer to function as the respective control blocks of the mobile terminal 1 (particularly, the respective components included in the control unit 5 and the image processor 14).

In this case, the mobile terminal 1 includes the computer including at least one control unit (for example, a processor) and at least one storage unit (for example, a memory) as the hardware for executing the above program. The program is executed using the control unit and the storage unit to realize the respective functions described in the above embodiments.

The program may be stored in one or more computer-readable recording media, not temporarily. The recording media may be included in the mobile terminal or may not be included in the mobile terminal. In the latter case, the program may be supplied to the mobile terminal via an arbitrary wired or wireless transmission medium.

Part or all of the functions of the respective control blocks may be realized by a logic circuit. For example, an integrated circuit including the logic circuit functioning as the respective control blocks is included in the scope of the present disclosure. In addition, the functions of the respective control blocks may be realized by a quantum computer.

### SUMMARY

An imaging apparatus (the mobile terminal 1) according to a first aspect of the present disclosure includes an imaging unit (the camera 10); the display unit 2 that displays an image captured by the imaging unit; a zoom processing unit (the image processor 14) that performs zoom processing to an image captured by the imaging unit; and an accepting unit (the operation unit 4) that accepts an input of an amount of processing by the zoom processing unit. The imaging unit includes the lens unit 11. A modulation transfer function value in a peripheral portion of the lens unit 11 is set so as to be lower than the modulation transfer function value in a central portion of the lens unit 11. The zoom processing unit performs the zoom processing so that the central portion is used in default shooting by the imaging unit and sets an angle of view resulting from the zoom processing as a default angle of view.

In the imaging apparatus according to a second aspect of the present disclosure, the imaging unit may have a 35 mm equivalent focal length of about 20 mm or less in the first aspect.

In the imaging apparatus according to a third aspect of the present disclosure, the lens unit 11 may be designed so that an area used at a certain value between about 23 mm and about 26 mm of the 35 mm equivalent focal length is within the central portion having higher modulation transfer function values in the second aspect.

In the imaging apparatus according to a fourth aspect of the present disclosure, the modulation transfer function value may be kept substantially constant in the central portion of the lens unit 11 and may be linearly decreased from a boundary with the central portion toward an outer edge of the lens unit 11 in the peripheral portion of the lens unit 11 in any of the first to third aspects.

The present disclosure is not limited to the above embodiments and various modifications may be made within the scope of the appended claims. Embodiments resulting from appropriate combination of technical measures disclosed in different embodiments are also included in the technical range of the present disclosure. In addition, combination of the technical measures disclosed in the respective embodiments may produce new technical features.

The present disclosure contains subject matter related to that disclosed in Japanese Priority Patent Application JP 2021-079365 filed in the Japan Patent Office on May 7, 2021, the entire contents of which are hereby incorporated by reference.

It should be understood by those skilled in the art that various modifications, combinations, sub-combinations and alterations may occur depending on design requirements and other factors insofar as they are within the scope of the appended claims or the equivalents thereof.

What is claimed is:

1. An imaging apparatus comprising:
an imaging unit;
a display unit configured to display an image captured by the imaging unit;
a zoom processing unit configured to perform zoom processing to an image captured by the imaging unit; and
an accepting unit configured to accept an input of an amount of processing by the zoom processing unit,
wherein the imaging unit includes a lens,
wherein a modulation transfer function value in a peripheral portion of the lens is set so as to be lower than the modulation transfer function value in a central portion of the lens, and
wherein the zoom processing unit performs the zoom processing so that the central portion is used in default shooting by the imaging unit and sets an angle of view resulting from the zoom processing as a default angle of view.

2. The imaging apparatus according to claim 1,
wherein the imaging unit has a 35 mm equivalent focal length of about 20 mm or less.

3. The imaging apparatus according to claim 2,
wherein the lens is designed so that an area used at a certain value between about 23 mm and about 26 mm of the 35 mm equivalent focal length is within the central portion having higher modulation transfer function values.

4. The imaging apparatus according to claim 1,
wherein the modulation transfer function value is kept substantially constant in the central portion of the lens and is linearly decreased from a boundary with the central portion toward an outer edge of the lens in the peripheral portion of the lens.
